(19) United States
(12) Patent Application Publication
(10) Pub. No.: US 2024/0352983 A1
(43) Pub. Date: Oct. 24, 2024

(54) WHEEL COMPONENT FOR BICYCLES WITH BRAKE DISK DEVICE

(71) Applicant: TRICKSTUFF GMBH, Pfaffenweiler (DE)

(72) Inventor: Klaus LIEDLER, Sölden (DE)

(21) Appl. No.: 18/601,487

(22) Filed: Mar. 11, 2024

(30) Foreign Application Priority Data
Apr. 18, 2023 (DE) 102023109704.0

(51) Int. Cl. F16D 65/12; F16D 65/02

(52) U.S. Cl. CPC F16D 65/123; F16D 2065/1316; F16D 2065/1384

(57) ABSTRACT

A wheel component for bicycles with a brake disk device with a disk holder (spider) and a brake disk provided to be attached to the disk holder. The brake disk opens up a disk plane. The disk holder includes a basic body having a central cross sectional plane, which extends in parallel to the disk plane. The basic body is configured with a plurality of bolts, which protrude in the axial direction and pass through the disk plane, to non-rotatably receive the brake disk on the disk holder. Fastening units are provided to secure the brake disk on the disk holder. Between the basic body of the disk holder and the fastening unit, an elastic damping component contacting the brake disk is received, to accommodate the brake disk on the disk holder float-mounted and noise-reducing.

### BACKGROUND

The invention relates to a wheel component for at least partially muscle-powered bicycles, wherein the wheel component comprises a brake disk device with a disk holder and a brake disk attached to the disk holder.

For decelerating bicycles, a variety of bicycle brakes have been disclosed which operate on different functional principles. In recent years, disk brakes have been increasingly proven in use, wherein friction linings are hydraulically urged against mostly metallic brake disks to achieve the required braking action.

The brake disk is attached indirectly or directly to the wheel hub. For attaching the brake disk to the wheel hub, systems have been disclosed wherein an adapter having a suitable internal toothing is pushed onto an end region of the hub provided with an external toothing, and is thus non-rotatably coupled with the hub. A fixing ring is screwed into an internal thread of the hub in the axial direction, to thus secure the adapter in the axial direction. Thus, the adapter is accommodated on the bicycle hub non-rotatably and axially fixed. The brake disk in turn is separately fixed to the adapter, or clamped between the fixing ring and the adapter. These systems permit the application of high braking forces in a variety of situations. To provide a reliable hold of the brake disk on the bicycle hub, the fixing ring must be attached using a suitably high rotational force so that the fixing ring will not automatically detach during use, which would cause unsafe operating situations.

DE 10 2005 033 765 A1 has disclosed a brake disk for bicycles received to be axially float-mounted. In this system, the brake disk can align itself axially suitably. Different structural conditions and different wear patterns on the two sides are automatically adjusted, since the brake disk can align itself axially suitably at all times. A drawback is the rattling noises as the brake disk axially swings back and forth in operation.

DE 10 2014 011 353 A1 has disclosed a float-mounted, axial configuration of the entire brake disk assembly in a “Centerlock System”, wherein an adapter with internal toothing is non-rotatably pushed onto an external toothing on the hub shell. The adapter with the brake disk attached is fixed axially outwardly by a retaining ring, so as to secure the brake disk assembly to the hub. The structure according to DE 10 2014 011 353 A1 has a coil spring inserted between the hub shell and the adapter, so that the adapter, to which the brake disk is fixed, can axially move counter to the spring force of the coil spring for aligning. This also allows axial alignment of the brake disk assembly as required. A drawback is that noises may occur in operation as the brake disk moves, or if thermal stresses show in the brake disk assembly. This may generate rattling and clicking noises in operation, thus worrying the users, who may fear failure of the brake system.

Another drawback of many known systems is that the brake disk, which tends to be riveted to the adapter, cannot be exchanged in the case of wear. Thus, the adapter and the brake disk require joint exchange, increasing work and costs.

In view of the prior art indicated above, it is the object of the present invention to provide a wheel component with a brake disk device for bicycles, which provides high quality and security and enables low-noise operation. A no-tools safety lock on a bicycle hub is also desirable.

### SUMMARY

A wheel component according to the invention for bicycles and, in particular, for bicycles operated in normal operation (on a regular or predominant basis) at least partially by muscular energy, comprises, or consists of, a brake disk device. The brake disk device comprises a disk holder and a brake disk provided for fastening to the disk holder. Alternately, the disk holder may be configured as a “spider”. Such a “spider” has arms protruding outwardly in the manner of a spider. The brake disk opens up a disk plane. The disk holder has a basic body with a (central) cross sectional plane which extends in parallel to the disk plane. The basic body is configured with a plurality of bolts, which protrude in the axial direction and pass through the disk plane, so as to receive the brake disk (non-rotatably) on the disk holder. At least one fastening unit is comprised to secure the brake disk to the disk holder. At least one elastic damping component contacting the brake disk is received between the basic body of the disk holder and the fastening unit, to accommodate the brake disk on the disk holder float-mounted and noise-reducing.

The wheel component according to the invention has many advantages. The structure according to the invention has the considerable advantage of ensuring a defined and dampened takeup of the brake disk on the brake disk device. Concurrently, the brake disk is movably received, provided for adapting its position to the situation. Also, interfering noises are avoided which might considerably worry the rider. The takeup or mounting of the brake disk, which dampens noises and is float-mounted due to the spring force of the damping component, allows a reliable and quiet operation, thus meeting highest requirements to the function and the riding experience.

Due to the connection and force transmission between the brake disk (friction ring) and the disk holder (spider), the invention also enables heat-related expansion and contraction of the brake disk. This occurs in conjunction with (absolute or nearly absolute) noiselessness. There will be no worrying clicking noises nor periodic or occasional clatter.

In the case that the brake disk heats up in operation due to frequent or sustained braking, the material expands due to heating. As a rule, the disk holder consists of a different material, and it heats up less. This is why its thermal expansion differs from that of the brake disk. Therefore, in normal, regular use, the components may show differences in thermal expansion. This may result in some movement of the brake disk, and more movement as it cools down. Then, known systems may have loud cracking noises during the relative motion, which may quite considerably worry the rider, since what is concerned is the braking system which is quite safety-relevant. The rider may worry whether the brake is still functional, having the required safety and reliability, since these heat-induced movements occur during, or shortly after, vigorous braking. These loud and irritating, and above all worrying noises can be reliably avoided by way of the invention.

The damping component comprises, or consists partially or entirely of, an elastic and resilient material. For example, the damping component may consist of a rubber-like material or of rubber. A damping component including a silicone material or natural rubber or another damping material is likewise conceivable. Also, the damping component may consist e.g. of two (or more) parts or components, wherein a part or a component is configured, or is naturally, spring-elastic. The other part or the other component may consist of a material which dampens vibrations, noise and oscillations, or may have an appropriate structure. Preferably, at least one damping component comprises, or is configured as, an O-ring. In simple configurations, the damping component comprises an O-ring of an elastic material, which is elastically compressed in the assembled state. The invention reliably prevents loud clicking noises during changes.

A bolt for taking up and retaining the brake disk may be referred to as a carrier bolt or a journal or carrier journal. Other suitable terms to describe the function and form include pin or carrier pin or carrier member.

In all the configurations, the brake disk is preferably received axially and/or radially float-mounted (in particular to the disk holder).

It is preferred for at least one elastic damping component to be received (preferably axially) between the disk holder (and, in particular, the basic body) and the brake disk. An elastic damping component is, in particular, received (preferably axially) between the basic body of the disk holder and the brake disk. It is likewise preferred for at least one elastic damping component to be received (preferably axially) between the brake disk and the fastening unit.

Preferably, multiple fastening units secure the brake disk to the bolts (which are configured e.g. in the shape of carrier journals). The bolts are, in particular, configured integrally with the basic body of the disk accommodation.

The bolts respectively their outer contours preferably each form an outer coupling contour to receive the brake disk. The cross section may be configured e.g. cylindrical, polygonal, round or rounded, or non-round. Preferably, the cross section is constant in the axial direction, at least in sections.

Preferably, at least one fastening unit has an enlarged head, which limits movement of the brake disk in the axial direction. In particular, at least one damping component is received between the enlarged head of the fastening unit and the basic body. The enlarged head of a fastening unit preferably bears (immediately) against the bolt. This means that the damping component may be disposed between the basic body and the brake disk and/or between the brake disk and the head.

In advantageous configurations, at least one bolt has an axial aperture (in particular, centered) respectively an axial bore (and, in particular, a through hole).

In particular, at least one bolt has an internal thread in the bore (axial aperture), in which a screw is inserted as a fastening unit. A (freely protruding) axial length of the bolt (to receive the brake disk) is preferably larger than the disk thickness of the brake disk in the accommodation region of the bolt. This leaves room for the damping component.

The disk thickness of the brake disk plus the axial width of the damping component, in the non-mounted (relaxed) state, is, in particular, larger than the axial length of the carrier journal. This means that in the mounted state the damping component is elastically biased.

It is preferred for (at least) one damping component each to be disposed on the two axial sides of the brake disk. For example, alternatingly on one and the other side. It is also possible for (at least) one damping component each to be disposed on at least one bolt on the two axial sides of the brake disk.

In other preferred embodiments, a spring part (without damping effect) is disposed on one of the axial sides of the brake disk, and on the other of the axial sides, a damping part (with or without resilience) is disposed. This subdivides the functions of springing/damping. Moreover, an entirely float-mounted takeup of the brake disk is enabled. Then, the elastic damping component may comprise two separate parts namely, one damping part and one spring part. It is also conceivable for both parts to be springing and damping.

A completely (and in both axial directions) float-mounted takeup is particularly preferred in the case that the brake disk is a friction ring that is narrow in the radial direction. Then, the bolts respectively bolt takeups for fastening the brake disk are located radially far outwardly. The bolts are, in particular, disposed over more than half the maximum diameter of the brake disk. Or, over a diameter larger than ⅔ or ¾ of the maximum diameter of the brake disk. “Floating” respectively a float-mounted takeup on a large diameter limits any tilting of the brake disk and thus a maximum axial displacement of the frictional region of the brake disk, where the brake disk makes actual contact with the brake contact surfaces in operation.

The invention preferably provides for the disk holder to be connected with the brake disk by screws instead of rivets. Thus, the connection is detachable, allowing to exchange the brake disk (of the friction ring) at low cost and with little resource expenditure, increasing sustainability. The disk holder is basically usable for any desired service life.

With its specific configuration including an O-ring, the structure allows axial and radial relative motions between the disk holder and the brake disk, absent any rattling or clacking.

A screw for a fastening unit only fixes the components stationary to one another, but there is no (or just negligible) force-transmitting function involved. The loads occurring during braking are discharged by way of the bolts and the disk holder.

The invention enables secure force transmission and noiselessness by way of the damping components. A safe concentric running of the brake disk is enabled, even with highest thermal loads.

A wheel component according to the application preferably also comprises a fixing ring for attaching a brake disk device to the hub shell of a bicycle hub. Alternately, the hub shell may be part of the wheel component.

The fixing ring preferably comprises a fixing unit extending (at least partially) in the radial direction, and a tube unit extending (at least partially) in the axial direction, with a thread formed thereon, for screwing the thread of the tube unit to the thread on the hub shell, and for attaching the brake device to a bicycle hub.

Furthermore, the wheel component may comprise a securing unit for securing the fixing ring.

Securely fixing the fixing ring can be achieved by way of form closure with a securing unit.

The brake disk device is fixed to a bicycle hub in the axial direction, in particular, by means of the fixing unit. The tube unit thread is set up and configured to screw with a matching thread on the hub shell. The fixing unit comprises at least one axial through hole which is configured and disposed such that the axial through hole is at least in partial axial alignment with an axial takeup in the brake disk device in the mounted (respectively screw-connected) state of the fixing ring, so that the securing arm of the securing unit can be inserted in the brake disk device takeup through the through hole in the fixing unit, so that the securing arm effects a safety lock for the fixing ring. In this way the fixing ring is prevented from detaching inadvertently.

Such a wheel component is very advantageous. One advantage consists in the option of attaching a safety lock not requiring any special tools. To this end, the securing arm of the securing unit is inserted through the axial through hole in the fixing unit into the brake disk device takeup, thus establishing an axial connection.

This achieves a high degree of security. Known systems employ e.g. a serrated disk between the brake adapter and the fixing ring. The rotation lock is effected via the interlocking serrations on the serrated disk and the fixing ring. To then detach the fixing ring from the attached state, a certain momentum must first be overcome so as to achieve a suitable securing of the fixing ring. The drawback thereof is the increased expenditure due to the different components required. Furthermore it may happen that the click-in elements for attaching the reference disk to the brake disk adapter break off, so that any securing against inadvertent detachment is eliminated, since the serrated disk and the fixing ring can then rotate jointly. These problems do not exist for the solution according to the application involving a securing unit.

In a preferred embodiment the securing arm provides an anti-twist protection in at least one direction of rotation. A securing arm, which is inserted through the through hole in the fixing unit into the brake disk device takeup, in particular, effects an anti-twist protection in at least one direction of rotation. To this end, the through hole and the brake disk device takeup are suitably configured to prevent inadvertent detaching of the fixing ring. An anti-twist protection in both directions of rotation is likewise possible.

In a preferred specific embodiment, a plurality of axial takeups is configured distributed over the circumference of the brake disk device. This inserts the securing arm into an axial brake disk device takeup in various suitable circumferential spots to effect a safety lock.

Particularly preferably, a plurality of axial through holes is configured over the circumference of the fixing unit. A plurality of axial through holes over the circumference of the fixing unit enables selecting a suitably oriented axial through hole which is at least partially aligned with an axial brake disk device takeup for inserting the securing arm of the securing unit and effecting a safety lock. This configuration is particularly advantageous since it achieves greater independence from the brake disk devices used.

Preferably, the distribution of the axial through holes is selected such that a safety lock of the fixing ring is enabled in any angular position of the fixing unit.

Using a plurality of axial through holes over the circumference of the fixing unit and/or using a brake disk device having a plurality of axial takeups over the circumference of the brake disk device enables more flexibility in design. Since the threads are not (necessarily) always aligned the same on the tube unit, multiple axial through holes and/or axial takeups make sense, so as to require no, or little, rotation of the fixing unit for achieving a (partial) axial overlap and enabling insertion of the securing arm. When using e.g. disk accommodations in various thicknesses, the fixing ring requires different depths of screw connections with the bicycle hub. This changes the circumferential position of an axial through hole respectively the plurality of axial through holes in the screw-connected state. Thus, using a plurality of through holes and/or axial takeups provides an aligned combination of an axial through hole and an axial takeup. Particularly preferably, the axial through holes are not distributed (exactly) evenly over the circumference. It is also possible to distribute at least some of the axial takeups irregularly over the circumference. The distribution of the axial through holes is selected such that securing is always/in any position feasible.

In all the configurations and specific embodiments it is particularly preferred to select a (circumferential and/or radial) distribution of the axial through holes so that a safety lock of the fixing ring is enabled substantially or nearly always or specifically in all the angular positions of the fixing unit. This applies, in particular, to angular positions which can be expected in the mounted (screw-connected) state. In this respect the distribution can be limited to a partial circumference that is highly probably sufficient. On the whole, the distribution of the axial through holes is preferably configured such that in the mounted state, a safety lock of the fixing ring is achieved, involving a rotational force within the specified range of rotational force. To achieve an orientation that is at least partially aligned, the degree of tightness can be slightly elevated or slightly lowered (in particular, within the tolerance range).

In advantageous specific embodiments the fixing unit comprises at least one fixing section extending in the radial direction, and then the axial through hole or at least one of the axial through holes is preferably configured on or in a fixing section. It is also possible and preferred for an axial through hole to be configured between two adjacent fixing sections. An axial through hole may for example be configured as a radially open groove. The radially open groove can be configured radially inwardly or radially outwardly open. The open groove does not need to extend in the radial direction only but its outline may have a circumferential element.

Particularly preferably, the fixing unit is configured as, or comprises, a circumferential fixing flange. The fixing flange preferably runs in complete circles. Alternately it is possible for the fixing flange to have interruptions. Then the fixing flange may be formed by a plurality of fixing sections extending in the radial direction, for example extending radially outwardly. These fixing sections may be referred to as fixing arms. The fixing sections do not need to run in the radial direction only but they may extend (slightly) in the axial direction, thus generally forming for example a (slight) cone. Then the brake disk or the brake disk device is supported on the radially outwardly ends or in the region of the radially outwardly ends of the fixing sections.

In particularly preferred configurations, the securing arm has an arm diameter smaller than the diameter of the axial through hole and/or the axial takeup. Then the securing arm can even be inserted if the axial through hole is not in perfect alignment with the axial takeup. In particular, the cross section of the axial takeup does not need to be entirely cleared. It is sufficient for a proportion of the cross section to be aligned and cleared so as to enable inserting the securing arm.

The fixing ring thread is preferably an external thread and can be screwed into an internal thread of the hub shell. It is also conceivable to have the fixing ring thread configured as an internal thread that screws with an external thread of the hub shell to attach the brake disk device respectively the brake disk to the bicycle hub.

In preferred configurations the fixing ring, and, in particular, the fixing unit, comprises at least one tool socket. Preferably, the tool socket includes at least one non-round contour to be gripped by an adapted tool. It is also possible for the fixing ring to have two or more different tool sockets. The tool socket may be configured as a tool takeup, or it may provide a spanner size, or some other (in particular, form-fit) socket for a tool.

In advantageous configurations the securing unit locks the tool socket in the mounted state. In particular, does the securing unit lock the tool socket so as to prevent form-fit and/or force-fit placing or applying of the tool (at least as a rule, or in the majority of applying attempts). This is very advantageous since it prevents inadvertent detaching while the securing unit is still mounted. Otherwise, a “forcible” detaching attempt might cause damage to the securing unit and/or the fixing ring. A mounted securing unit locking the tool socket prohibits destruction of the anti-twist protection in the case of incorrect handling, because the tool cannot be applied at all.

In the mounted state, the brake disk device is preferably disposed on one axial side of the fixing unit, and the tool socket is configured on the other axial side of the fixing unit. In all the configurations the tool socket may be configured as a type of radial toothing (radially inwardly or radially outwardly).

It is possible and preferred for the tool socket to be radially configured on the tube unit. The tool socket may be configured radially inwardly and/or radially outwardly on the tube unit (or the fixing unit). The tool socket may, in particular, also be (axially) configured at one axial end.

It is particularly preferred for the tool socket to be configured such that the tool socket can for example be gripped by a sprocket tool or a rotor tool. These tools are in common use for bicycles. If an existing tool can be used, the number of further special tools is kept down. Thus, maintenance/repairs do not require another special tool, which increases sustainability and reduces the investment costs.

In particularly preferred configurations, the fixing ring and, in particular, the fixing unit has a substantially circumferential groove. Particularly preferably the groove runs around the entire circumference. In particularly advantageous configurations, the groove runs in the gripping region of the tool (in the radial toothing).

In preferred specific embodiments, the securing unit comprises a securing spring with a spring body extending (at least in sections) arcuate. Particularly preferably the securing arm protrudes transverse from the spring body. The securing arm may run transverse (perpendicular, or also obliquely) to a plane opened up by the arcuate spring body. It is also possible for at least one section of the spring body to protrude radially from the arcuate spring body.

In all the configurations it is particularly preferred for the securing spring to be configured in a form-fit, and, in particular, by adhesive bond, and particularly preferably integrally. In simple and particularly preferred configurations the securing unit consists of a resilient wire material, comprising an arcuate spring body, from which an end portion or a section in the vicinity of the end protrudes transversely, forming a securing arm.

Particularly preferably, the securing spring bears flexibly resiliently against the fixing ring in the mounted state. Particularly preferably, the spring body encloses the fixing ring.

In particularly advantageous configurations, the groove is configured on the tool socket, and the securing spring and, in particular, the spring body is (at least substantially) received in the tool socket groove in the mounted state. It is particularly advantageous for the spring body to be received at a resilient bias in the tool socket groove, and for the securing arm to extend from the spring body through the through hole on the fixing unit into an axial brake disk device takeup, so as to secure the fixing ring and prohibit its inadvertent detachment.

Particularly preferably, the groove has dimensions so that in the mounted state, which may be referred to as a secured state, the spring body radially protrudes out of the tool socket groove. The spring body may protrude radially inwardly and/or outwardly from the groove. In the case of a groove configured on the outer periphery of the fixing ring, the spring body protrudes radially outwardly in the mounted state. In the case of a tool socket configured radially inwardly, however, the spring body protrudes radially inwardly from the groove. And in the case of a tool socket configured axially outwardly, the spring body can axially protrude (somewhat) from the groove.

Particularly preferably the wall thickness of the spring body is greater than the depth of the groove. In all the configurations the spring body may, in particular, have a round, oval, rounded, or polygonal cross section. Preferably, the cross section of the spring body does not change, or only very little, at least in sections.

In the mounted state, the spring body is particularly preferably received in the tool socket such that the tools cannot be applied to the tool socket. This is achieved, in particular, in that the spring body changes the resulting contour of the tool socket so that the tool cannot be placed against the tool socket at all, or at any rate not in a form fit or force fit. In this way, with a securing unit mounted, attempts to detach or attach the fixing ring are reliably prohibited. This prevents damage to a wheel component.

In preferred configurations the wall thickness of the spring body is between 0.5 mm and 3 mm, and/or the external diameter of the securing spring is between 20 mm and 50 mm. The length of the protruding securing arm is, in particular, between 3 mm and 12 mm.

Advantageously, the spring body opens up a plane to which the securing arm is oriented transverse. Alternately, the securing arm may be referred to as a safety section of the spring body.

In particular, in the mounted state, the spring body has an angle at circumference of more than 180°. In particular, in the mounted state, the angle at circumference of the spring body is less than 360°. In particularly preferred configurations, the angle at circumference in the mounted state is between 270° and less than 360°, and particularly preferably, the angle at circumference is between 300° or 330° and 355°. With the spring body surrounding the fixing ring, the angle at circumference may also be referred to as angle of contact.

In advantageous configurations the securing arm, in the mounted state, encloses at least some sections of the fixing ring, and, in particular, has a diameter between 40 mm and 50 mm.

The brake disk may preferably be exchanged as required, while the disk holder continues to be used.

The disk holder can, in particular, be non-rotatably connected with the bicycle hub and it is preferably configured such that in the mounted state, the disk holder bears against a shoulder of the hub shell (in a form fit). Thus, the disk holder is reliably received in, and supported on, the bicycle hub.

It is also possible for the disk holder to be provided to be attached to a separate adapter unit, which in turn can be attached to the hub shell. Then, there are virtually two intermediate components, the disk holder to immediately retain the brake disk for one, and for another, an adapter unit for attaching the disk holder to the hub shell. This allows using e.g. a centerlock adapter, to which in turn a holder (a so-called “spider”) with six arms and a 6-hole fastener for the brake disk is attached.

In other configurations it is also conceivable for the disk holder to be connected with the bicycle hub by adhesive bond. It is also possible for the disk holder to be configured integrally with the bicycle hub or the hub shell of the bicycle hub. Then, the bicycle hub forms part of the wheel component.

In preferred configurations, at least part of the bolts or at least one of the bolts has a depression, which is accessible in the mounted state, as an axial takeup (at the axial end of the bolt). Preferably, in the mounted state the securing arm engages a depression of a bolt. It is also possible for part of the depressions and/or the bolts to be covered in the axial direction by the fixing ring in the mounted state.

It is also possible for the securing arm in the mounted state to engage in an axial takeup on the disk holder of the brake disk. To this end, the circumference of the disk holder may be configured with takeups in the shape of through bores or blind holes, into which the securing arm of the safety device engages, thus preventing inadvertent detachment of the fixing ring. The disk holder comprises, in particular, an internal toothing which is non-rotatably coupled with an external toothing of the hub shell. The securing arm of the securing unit connects the fixing ring non-rotatably with the disk holder, so that the fixing ring cannot detach inadvertently.

It is also possible and preferred for the securing arm in the mounted state to engage in a brake disk aperture. Then the disk aperture forms the axial takeup. A safety lock of the fixing ring may also be provided by engagement of the securing arm in an axial takeup configured as a disk aperture in the brake disk. This is for example also possible if (only) one anti-twist protection is provided (substantially) in one direction of rotation, and only (slight) automatic return rotation of the fixing ring is enabled. Further return rotation is blocked by the securing arm at the latest following a (small) rotation angle.

It is also possible and preferred to use a (another) cutout in the brake disk as an axial takeup. Such a cutout may be made in the brake disk for example for weight reasons, or it may be provided for reducing heat transfer from the brake region to the bicycle hub, or for cooling. These configurations also allow the axial takeup to only block unscrewing of the fixing ring. A certain and stronger tightening of the fixing ring might still be possible. Thus, return rotation (in the detaching direction) by less than 0.5° or 1° or 2° or 5° may be enabled until the securing arm makes contact with a side wall of the axial takeup. However, further rotation by 1° or 2° or 5° or 10° or more may be possible or conceivable in the other direction of rotation (in the fixing direction). A rotational angle limit (fixing) in both directions of rotation may, but does not need to, be provided.

In particularly preferred configurations, one bolt of the disk holder is received in the disk aperture in the mounted state. Preferably all the bolts are received in one disk aperture each of the disk holder.

In all the configurations, multiple axial through holes are preferably provided. Particularly preferably, multiple adjacent through holes have the same circumferential distances. However, it is also preferred for the circumferential distance of at least two adjacent through holes to differ from the circumferential distance of two other adjacent through holes.

A suitable configuration of axial through holes over the circumference may on the whole provide for an axial takeup to be aligned with an axial through hole, in any angular position of the fixing ring relative to a brake disk device, in at least one position, to enable insertion of a securing arm.

If insertion of the securing arm is prohibited in a specific angular position, a suitable (slight) increase or decrease of the tightening momentum of the fixing ring may adapt the angular position of an axial through hole so that an (optionally different) axial through hole is sufficiently aligned with an axial takeup.

Particularly preferably, the external diameter of the fixing unit is larger than the (mean or typical) diagonal distance of the axial takeups. For example with a plurality (e.g. of identical) axial takeups disposed in a circle, the external diameter of the fixing unit is preferably larger than this circle diameter. Thus, it is ensured that the brake disk is fixed not only radially inwardly of the takeups, which would allow a “baggy” brake disk. If the fixing unit does not only act radially inwardly but (also) in the radially outwardly region of the disk holder (brake disk takeup), an otherwise conceivable bag-like deformation of the brake disk can be prevented.

The applicant reserves the right to claim separate protection for a wheel component with a bicycle hub, comprising a hub shell and a disk holder and a fixing ring, for attaching a (separate) brake disk to the bicycle hub, wherein the disk holder has (immediately) axially outwardly (i.e. directed outwardly away from the central hub region) bolts which can non-rotatably receive the brake disk, wherein the disk holder is configured integrally (or of one single material) with the hub shell, and disposed in an axial end region of the hub shell (respectively is formed by an axial end portion of the hub shell), and wherein a thread is formed on the inner periphery of a longitudinal section of the disk holder, so as to attach a brake disk in the axial direction to the bicycle hub, by screwing the thread configured on the fixing ring to the thread on the disk holder.

Furthermore, this wheel component comprises a brake disk, the brake disk forming a brake disk device with (or on) the disk holder. An elastic damping component (between the disk holder and the brake disk) dampens relative motions of the brake disk relative to the disk holder and reduces noise, if e.g. the brake disk slightly moves due to thermal stresses.

Such a wheel component comprises, in particular, (at least) one securing unit for securing the fixing ring, the fixing ring comprising a fixing unit extending in the radial direction, and a tube unit extending in the axial direction, on which the thread (on the tube unit) is configured, to screw the thread of the tube unit with the thread (on the disk holder respectively) on the hub shell, and to attach the brake disk device to a bicycle hub, wherein the fixing unit comprises at least one axial through hole which is configured and disposed such that the axial through hole is at least in partial axial alignment with an axial takeup in the brake disk device when the fixing ring is in the mounted state, so that the securing arm of the securing unit can be inserted through the through hole in the fixing unit into the takeup of the brake disk device, so that the securing arm effects a safety lock for the fixing ring so as to prevent inadvertent detachment of the fixing ring.

In preferred specific embodiments the fixing ring and the bicycle hub may have features as described above.

In all the configurations it is preferred for at least part of the front surfaces of the bolts, (or the front surfaces of the bolts on the whole), to have a different colour or surface property. For example the (axial) surface may be configured not black but e.g. in a silver colour. The advantage thereof is greater ease of identifying the holes (depressions) in the bolts during mounting. In the case of entirely black takeups the presence or absence of a hole or depression (in particular, for receiving one end of a securing arm) may be difficult. It is also possible to provide an additional surface property, or instead of the colour, a (another) different surface property, e.g. shiny instead of dull.

Further advantages and features of the present invention can be taken from the description of the exemplary embodiments which will be discussed below with reference to the enclosed figures.

### BRIEF DESCRIPTION OF THE DRAWINGS

The figures show in:

FIG. 1a a schematic illustration of a mountain bike with wheel components according to the application;

FIG. 1b a schematic illustration of a racing bicycle with wheel components according to the application;

FIG. 2a an exploded view of the brake disk device according to the application;

FIG. 2b a perspective cross sectional view of the connection of the brake disk and the disk accommodation;

FIG. 2c a cross sectional view of the connection of the brake disk and the disk accommodation according to FIG. 2b;

FIG. 2d a cross sectional view of a variant of the connection of the brake disk and the disk accommodation according to FIG. 2b;

FIG. 2e an exploded view of another brake disk device according to the application;

FIG. 3 a perspective illustration of a bicycle hub;

FIG. 4 a schematic illustration of a brake disk;

FIG. 5 a perspective illustration of a securing unit, a fixing ring, and a disk holder for the hub according to FIG. 3;

FIG. 6 an exploded view of a wheel component according to the application, and the wheel component in the mounted state;

FIG. 7 the disk holder in FIG. 6;

FIG. 8 the securing unit in FIG. 6;

FIG. 9 a top view of the fixing ring without a securing unit and with a mounted securing unit;

FIG. 10 a top view of the fixing ring with a mounted securing unit;

FIG. 11 a perspective view of another bicycle hub; and

FIG. 12 another schematic illustration of a wheel component according to the application.

### DETAILED DESCRIPTION

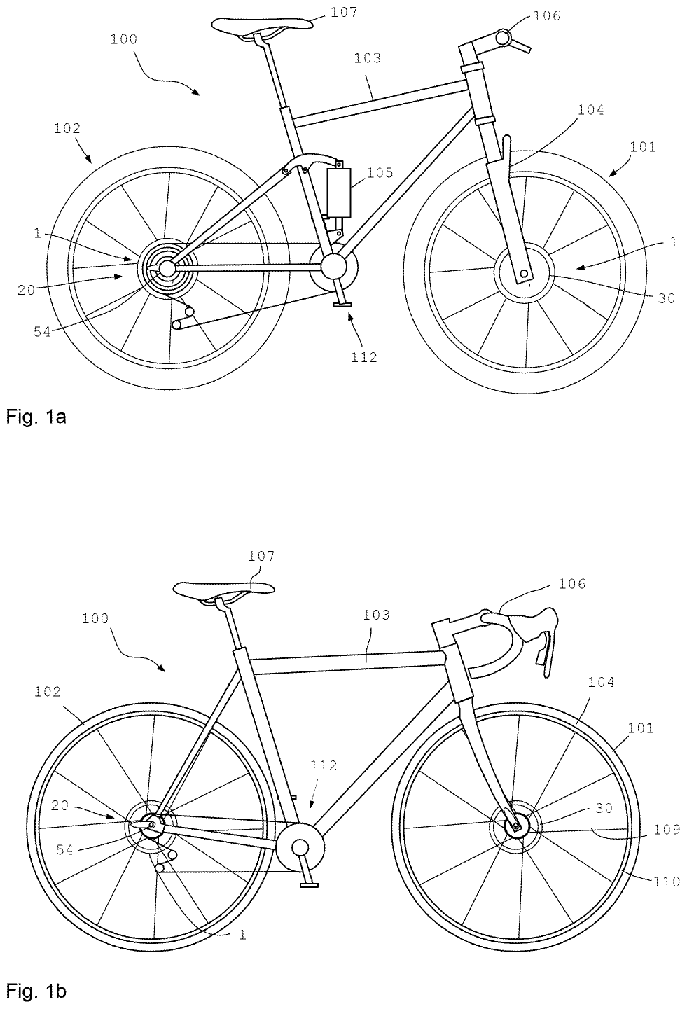

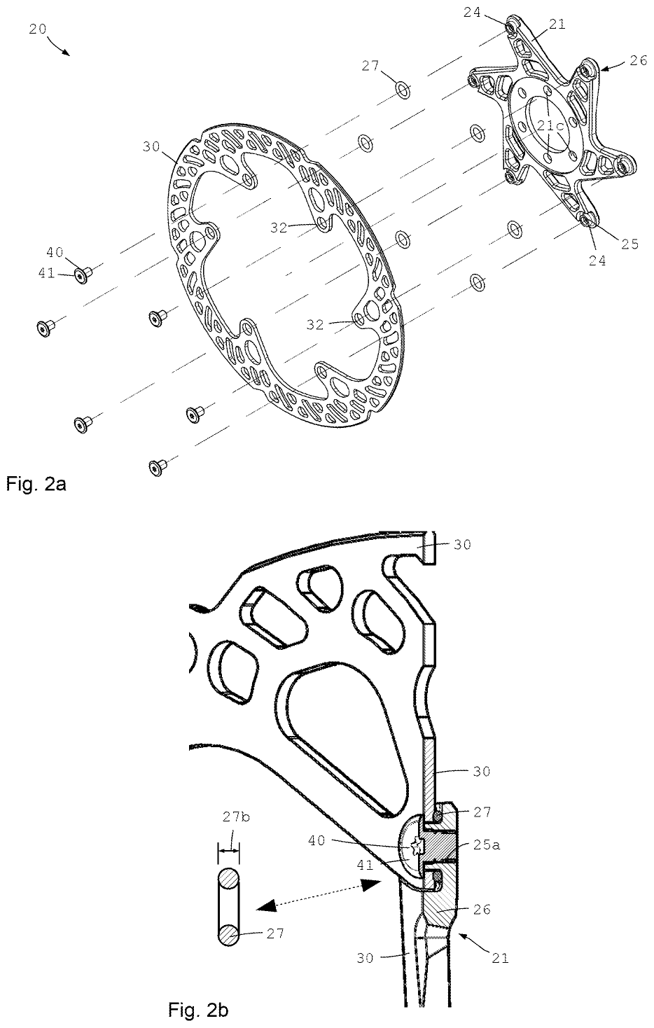

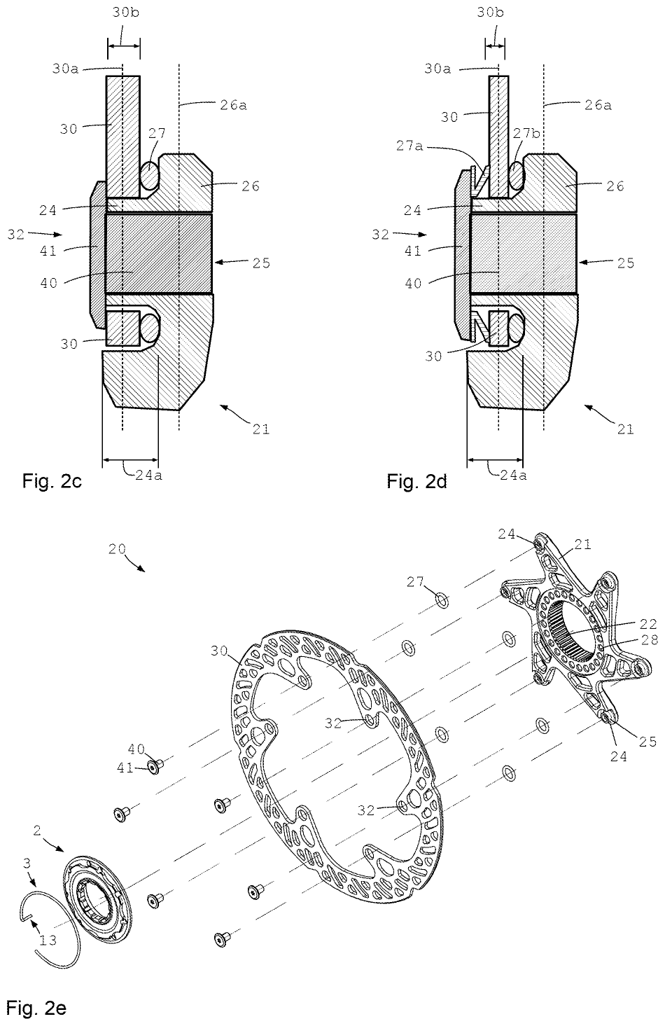

The FIGS. 1a and 1b show a mountain bike respectively a racing bicycle 100, each equipped with wheel components 1 according to the invention. The mountain bike respectively racing bicycle 100 is provided with a front wheel 101 and a rear wheel 102, with a brake disk device 20 each attached, secured by means of a fixing ring 2 not visible in the FIGS. 1 and 2. Each of the two wheels 101, 102 is provided with spokes 109 connecting the rim 110 with the pertaining hub.

A bicycle 100 comprises a frame 103, a handlebar 106, a saddle 107, a fork or suspension fork 104 and in the case of the mountain bike, a rear wheel damper 105 may be provided. A pedal crank 112 with pedals serves for driving. Optionally the pedal crank 112 and/or the wheels may be provided with an electrical auxiliary drive. The hubs of the wheels may be attached to the frame or the fork by means of a clamping system 54 (for example a through axle or a quick release).

The FIGS. 2a to 2c schematically illustrate a preferred exemplary embodiment of the invention. A conceivable wheel component 1 according to the application is schematically illustrated in FIG. 2a in an exploded view. In this configuration, the wheel component 1 comprises a brake disk device 20 with a disk holder 21, presently configured as a spider, with six arms protruding radially. A brake disk 30 can be detachably attached to the disk holder 21. The brake disk 30 defines a disk plane (see FIG. 2c). The disk holder 21 shown is provided with a 6-hole takeup with mounting holes 21c for attachment to a hub 50.

The disk holder 21 comprises a basic body 26 (see, in particular, FIG. 2c) having a central, cross sectional plane 26a, which extends in parallel to the disk plane 30a. The two planes may in theory extend interlocked (i.e. at no distance). The basic body 26 is configured with a plurality of bolts 24. The radially outwardly ends of the six arms shown, each include an (integral) bolt 24, extending in the axial direction 5 and passing through the disk plane 30a, to securely accommodate the brake disk 30 on the disk holder 21. Each of the bolts 24 of the disk holder 21 has an assigned fastening unit 40 to secure the brake disk 30 on the disk holder 21. Here, screws 40 with enlarged screw heads 41 are provided.

Alternately it is possible for a fixing ring 2 to comprise e.g. a circumferential fixing flange, to simultaneously cover all of the bolts 24 axially outwardly and thus to secure the brake disk in the axial direction 5 on the disk holder 21. Such a configuration is illustrated e.g. in FIG. 2e and in FIG. 6.

In any case, the brake disk 30 is retained and supported by the bolts 24.

The FIGS. 2a to 2c show that between the basic body 26 of the disk holder 21 and the fastening unit 40, at least one elastic damping component 27 contacting the brake disk is received, to accommodate the brake disk 30 on the disk holder 21 float-mounted and noise-reducing, and to elastically bias it to a defined position. Each of the bolts 24 shown is provided with an elastic O-ring as the damping component 27. The O-ring surrounds the bolt 24. The brake disk 30 bears axially against it. Movements of the brake disk 30 are dampened by the elastic damping component 27. Thus, noises during thermal motions of the brake disk 30 are largely suppressed.

The fastening units 40 configured as screws each show an enlarged head 41, which limits motions of the brake disk 30 in the axial direction 5. The enlarged head 40 of the fastening unit 40 bears against the bolt 24.

At least one damping component 27 each is received between the enlarged head 41 of the fastening unit 40 and the basic body 26. It is conceivable to dispose one O-ring 27 each on the two axial sides of the brake disk 30. It is also possible to dispose a spring member on one of the axial sides, and on the other of the axial sides, a damping component. Then, the damping function and the springing function are provided on, or divided between, both sides.

The bolts 24 each show an axial bore 25, in which an internal thread is configured, into which a screw is screwed as a fastening unit 40.

A freely protruding axial length 24a of the bolt 24 to receive the brake disk 30 is larger than the disk thickness 30b of the brake disk 30 in the accommodation region of the bolt 24. The dimensions are such that the disk thickness 30b of the brake disk 30 plus the axial width (diameter) of the damping component 27 is larger in the non-mounted state than is the axial length 24a of the bolt 24. This causes elastic compression of the O-ring 27 during mounting.

FIG. 2d illustrates a cross sectional view of a variant of the connection of the brake disk with the disk accommodation according to FIG. 2b. In this configuration, the elastic damping component 27 according to FIG. 2b comprises two parts, one (separate) spring part 27a and one (separate) damping part 27b, which together provide the elastic damping component 27 or its function respectively. In this configuration, the springing function and the damping function may be separate. It is also conceivable to use two identical springing and damping parts, so as to mount identical components on the two axial sides. To provide for the appropriate functionality, the screw head may be enlarged. The brake disk is preferably identical in all configurations.

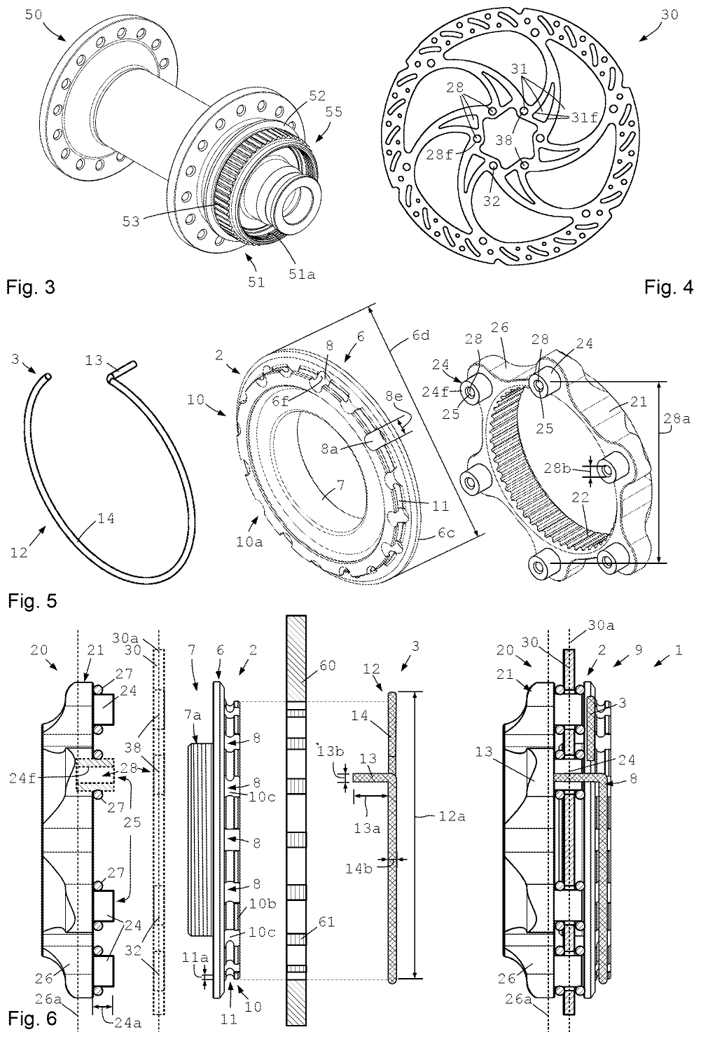

FIG. 2e schematically shows another wheel component according to the invention in an exploded view. In this configuration, the wheel component 1 comprises a brake disk device 20 with a disk holder 21, presently configured as a spider, again with six arms protruding radially. Again, a brake disk 30 is detachably attached to the disk holder 21. The brake disk 30 likewise defines a disk plane, as it is shown in FIG. 2c or in FIG. 2d. Unlike the exemplary embodiment according to FIG. 2a, the disk holder 21 shown comprises an internal toothing 22, which allows a non-rotatable connection with a corresponding external toothing 53 (see FIG. 3) on the hub shell 51. This is, in particular, a connection type which has become known under the trade name “Centerlock”. Basically, another non-round coupling type may be selected.

To secure the disk holder 21, a fixing ring 2 is inserted, which will be described below in more detail with reference to the FIGS. 5 and 6. To secure the fixing ring 2, a securing unit 3 is used, which in simple configurations consists of a bent wire, from which a securing arm protrudes transversely (i.e. axially).

The difference to the configurations according to FIGS. 2a and 2e is that in FIG. 2a, the disk holder 21 is non-rotatably received in a 6-hole takeup of the hub, while in FIG. 2e the disk holder 21 is non-rotatably coupled with a non-round contour of the hub.

FIG. 3 shows a perspective illustration of a hub respectively bicycle hub 50, presently configured as a front wheel hub. The invention may also be used in rear wheel hubs. The bicycle hub 50 respectively the front wheel hub comprises a hub shell 51 on which a takeup device 55 is configured for attaching a brake disk device 20 (see FIG. 6).

To this end, the takeup device respectively the hub shell 51 comprises a toothing 53, which is configured on the outer periphery of the takeup device 55. The takeup device is configured on a tube-like section extending axially outwardly on one end of the hub shell. In the inner circumferential region of this tube section forming the takeup device 55 for the brake disk device 20, a thread 51a is configured. This thread 51a is an internal thread. A fixing ring 2 is screwed to the thread 51a, after placing the brake disk device 20 on the toothing 53.

FIG. 4 shows a schematic side view of a brake disk 30 of a brake disk device 20. The brake disk 30 comprises multiple disk apertures 38 and cutouts 31, wherein each of which can form one axial takeup 28 for the securing arm 13 of the securing unit 3 of FIG. 5. The axial takeups 28 respectively disk apertures are each delimited by a wall 28f. The cutouts 31 are delimited by a wall 31f in the brake disk.

FIG. 5 shows on the left the securing unit 3 for securing the fixing ring 2, shown in the center part in FIG. 5. On the right in FIG. 5, the disk holder 21 of the brake disk device 20 is shown in perspective.

The securing unit 3 comprises a securing spring 12 with an arcuate spring body 14, from which a securing arm 13 protrudes that is configured integrally therewith. The securing unit 3 is provided and configured to be received in the groove 11 on the fixing ring 2, so as to secure the retaining ring 3 screwed to the bicycle hub 50 against inadvertent detachment.

The fixing ring 2 comprises an axially extending tube unit 7 and a fixing unit 6 extending radially outwardly therefrom in an end region. This fixing unit 6 comprises a circumferential fixing flange 6c with which one brake disk 30 is secured axially outwardly.

One can see in FIG. 5 the tool socket 10 having a non-round contour 10a. The fixing ring 2 can be gripped by the non-round contour 10a in a form-fit and/or force-fit by means of a suitably configured tool 60 (see FIG. 6), so as to reliably screw the fixing ring 2 with the hub shell 51 of the bicycle hub and to apply the rotational force required.

In screwing, the brake disk 30 (for example that in FIG. 4) is reliably secured on the disk holder 21 in the axial direction. After screwing, the securing unit 3 can be mounted. To this end, the spring body 14 of the securing spring 12 is placed in the groove 11 on the tool contour 10, wherein first the securing arm 13 is passed through a through hole 8 in the fixing unit 6, so that the securing arm 13 engages in an axial takeup 28 (for example) in the disk holder 21. The securing arm 13 shows an arm diameter 13b (see FIG. 6) which is smaller than the diameter 8e of the axial through hole 8, presently in the shape of a through hole 8a. The arm diameter 13b is, in particular, also smaller than the diameter 28b of an axial takeup 28. This enables inserting the securing arm 13 through the axial through hole 8 into the axial takeup 28, even if the two apertures (8, 28) are not in perfect axial alignment. In particular, does the cross section of the axial takeup 28 not need to be entirely cleared.

Here the disk holder 21 shows an internal toothing 22, configured to match the external toothing 53 on the hub 50 in FIG. 3. After pushing the disk holder 21 onto the toothing 53, the disk holder 21 is thus non-rotatably coupled with the hub 50. Six bolts 24 are configured on, or inserted in, the disk holder 21, disposed evenly spaced over the circumference at angular distances of 60°, and serving for proper stopping and transmitting the rotational force of the brake disk 30 generated in braking.

The brake disk 30 in FIG. 4 shows corresponding disk apertures 38, again at angular distances of 60°. The diameters of the disk apertures 38 match the external diameters of the bolts 24 of the disk holder 21, so that the brake disk 30 with the disk apertures 28 can be non-rotatably received on the disk holder 21.

Thus, although the brake disk 30 is non-rotatably received on the hub 50, it can still be pulled off the hub 50 in the axial direction. To secure the brake disk 30 in the axial direction as well, the thread 7a of the fixing ring 2 is screwed to the thread 51a of the hub 50. To this end, the tool 60 is placed against the tool contour, and the required rotational force is applied.

Thereafter, the securing unit 3 is mounted so that the securing arm 13 protrudes into the depression 25 as a takeup 28 for the disk holder 21, passing through an axial through hole 8. Thus, the brake disk 30 is non-rotatably received in the bicycle hub 50, and is fixed and secure in the axial direction. In the inserted state, a rotary motion of the fixing ring is delimited in that the securing arm 13 bears against the wall 6f surrounding the through hole 8a and against the wall 24f of the bolt 24. The securing arm 13 thus delimits respectively prevents relative rotation of the fixing ring relative to the disk holder 21 or the brake disk 30, and thus the brake disk 30 is received secure against loss. Detaching is prevented as well.

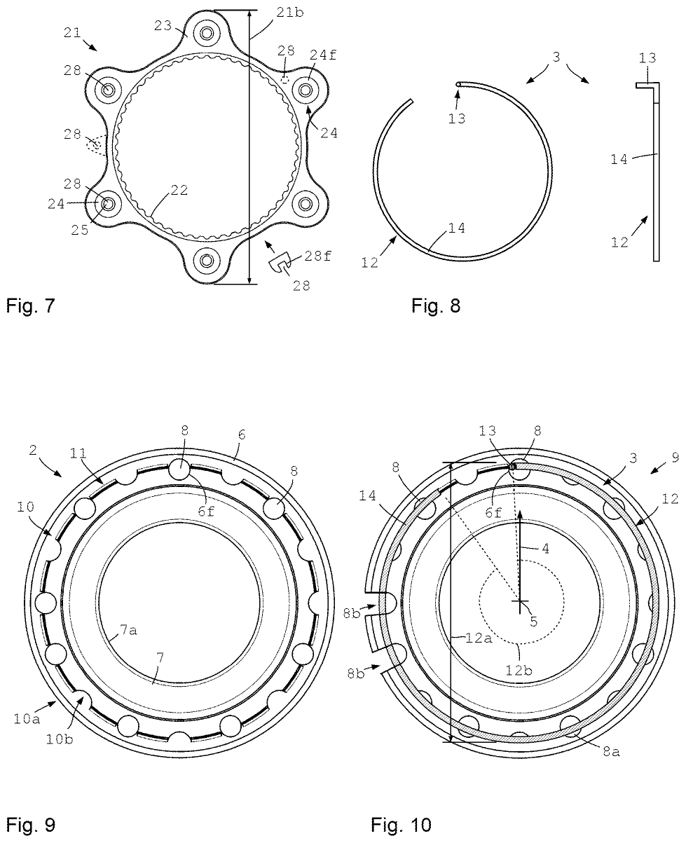

The fixing unit 6 and here, the fixing flange 6c, shows an external diameter 6d that is larger than the diagonal distances 28a of the takeups 28. Here, the external diameter 6d of the fixing unit 6 is also larger than a circle surrounding the bolts 24 as closely as possible. It is thus ensured that the brake disk is not only pressed in the radially inwardly region, and a bag-like deformation of the brake disk is prevented. The maximum external diameter 21b (FIG. 7) of the disk holder 21 (approximately) corresponds to the external diameter 6d of the fixing unit 6.

FIG. 6 shows on the left, an exploded view of the wheel component 1, and on the right, the mounted state 9 of the wheel component 1. On the extreme left, the disk holder 21 of the brake disk device 20 can be seen, from which the bolts 24 protrude axially to the right, away from the surface. The bolts 24 may be configured integrally with the disk holder 21, or may be inserted in the disk holder 21 as separate parts. The bolts 24 preferably show a depression 25 or a central hole, which is presently axially opened to the right, so that the depression 25 can form an axial takeup 28 for anti-twist protection. The depressions 25 each show a peripheral wall 24f.

The bolts 24 already include an elastic O-ring pushed on as a damping component 27. The damping components 27 dampen motions of the brake disk in operation and thus quite considerably reduce the noises occurring. Sudden thermal motions of a hot brake disk do not result in loud clicking noises, which may annoy and worry riders.

On the right, next to the disk holder 21, a brake disk 30 is schematically illustrated in section. Only a central cutout of the brake disk 30 is shown. In the brake disk of FIG. 4, the region shown in the image 6 approximately corresponds to the central region radially outwardly up to the disk apertures 38, and thus less than half the diameter. It can be seen that the disk apertures 38 in the brake disk match the bolts 24, so that the brake disk 30 can be non-rotatably received on the disk holder 21.

On the right next to the brake disk 30, a fixing ring 2 is shown. The tube unit 7 extends from the fixing unit 6 to the left in the direction of the brake disk 30. The thread 7a can be recognized externally on the tube unit 7, with which the fixing ring is screwed to the bicycle hub 50.

The fixing unit 6 protrudes radially outwardly from the tube unit 7, and serves to axially secure the brake disk 30. The tool contour 10, on which the circumferential groove 11 is configured, follows axially to the right. The depth 11a of the groove 11 is shown in the drawing. Engagement components 10b are configured over the circumference of the tool contour 10. Axial grooves 10c are configured between the engagement components 10b, shown in alignment with the axial through holes 8.

Further to the right of the fixing ring 2, a simplistic tool 60 is shown, which can be applied on the tool contour 10 of the fixing ring 2. Then, the engagement components 61 of the tool 60 engage in the engagement components 10b of the tool contour 10a of the tool socket 10. The closely fitting orientation enables a non-rotatable connection of the tool 60 and the fixing ring 2, so as to allow transfer of high rotational forces to the fixing ring 2. Here the engagement components 61 of the tool 60 are pushed into the axial grooves 10c of the tool socket 10, to attach or detach the fixing ring 2.

After screwing the fixing ring 2 to the bicycle hub 50, an axial through hole 8 in the fixing ring 2 in alignment with an axial takeup 28 of the brake disk device 20 is found, into which the securing arm 13 of the securing unit 13 is pushed. Thereafter the spring body 14 of the securing spring 12 of the securing unit 3 is inserted in, and clicked into, the groove 11. Although the spring body 14 of the securing spring 12 clicks firmly into the groove 11, it can optionally, and as required, be manually lifted out of the groove 11, to demount the fixing ring 2 if required.

Since the spring body 14 has a wall thickness 14b greater than the depth of the groove 11, part of the spring body 14 protrudes radially outwardly. This is another reason why in the mounted state the tool 60 cannot be applied to the tool socket 10. As a result, the securing unit 3 enables a safety lock of the fixing ring 2 and thus, reliable and firm fixing of the brake disk device 20 to the bicycle hub 50, while applying the tool 60 and unscrewing the fixing ring 2 is not enabled until the securing unit 3 is detached.

On the right, the FIG. 6 shows the mounted state 9.

The damping components are received biased between the disk holder 21 and the brake disk 30. The brake disk 30 can be axially secured by means of the circumferential flange of the fixing ring 2. It is also possible to secure the brake disk 30 by screws (as fastening units 40) which are screwed into internal threads 25a (see FIG. 2c). Then, the fixing ring secures the basic body 26 of the disk holder 21.

On the right, FIG. 6 shows a secured state. It can be seen that the spring body 14 of the securing unit 3 is received in the groove 11 on the fixing ring 2, and that the securing arm 13 extends through the axial through hole 8 of the fixing ring 2 into an axial takeup 28 of the disk holder 21. For better clarity, the securing arm 13 is also shown in the interior of the bolt 24, although it is really surrounded by the bolts 24 and therefore is actually not visible. The securing unit 3 blocks the tool socket 10 in the mounted state 9. Thus, the tool 60 with the engagement components 61 cannot be brought to form-closed engagement with the tool contour 10 for unscrewing the fixing ring 2. Pushing the engagement components 61 into the axial grooves 10c of the tool socket 10 is blocked. The fixing ring 2 is prohibited from twisting and thus detaching in that the securing arm 13 bears against the walls 6f and 24f.

FIG. 7 shows a top view of a disk holder 21 according to the FIGS. 5 and 6, with some modifications additionally shown in broken lines. On the inner periphery, the disk holder 21 has an internal toothing 22 to non-rotatably connect the disk holder 21 with a bicycle hub 50. Arms 23 protrude radially outwardly, on which one bolt 24 each is configured or received. Here, each of the bolts 24 has a depression 25, wherein each of the depressions 25 can serve as an axial takeup 28 for a securing arm 13. Each of the depressions 25 is surrounded by a wall 24f of the bolt 24.

The image 7 additionally shows on the top right, in broken lines, a depression (here, circular or oval) or bore as an axial takeup 28 adjacent to one of the bolts 24. A safety lock of the fixing ring 2 is also feasible by pushing the securing arm 13 into these separate depressions or holes in the body of the disk holder 21.

It is also possible for separate appendices to be configured on the outer periphery, as shown in broken lines on the left in FIG. 7, wherein a separate appendix or a separate arm shows an axial takeup 28 to take up one end of a securing arm 13. It is also possible for two or more adjacent depressions or axial takeups 28 to be formed on such an arm or appendix. Such a takeup 28 does not need to be configured as a depression or bore or the like that is entirely surrounded by material. It is also possible to configure such an axial takeup 28 as a radially open groove. For example, the FIG. 7 shows on the bottom right such an appendix, which may for example be formed integrally with the body of the disk holder 21. An axial takeup 28 is configured radially outwardly, in which the end of a securing arm can be axially (or radially) inserted to effect an anti-twist protection. The takeup 28 shown is not surrounded by a wall 28f in its entirety.

FIG. 8 shows a top view of the securing spring 12, with the securing arm 13 at the top end protruding axially, and presently perpendicular to the plane of the drawing. On the right adjacent thereto, a side view can be seen, showing that the arcuate spring body 14 extends within a plane out of which the securing arm 13 projects, here orthogonally.

FIG. 9 shows a top view of the fixing ring 2 without a mounted securing unit 3, and FIG. 10 shows a view with a mounted securing unit 3.

Some modifications are additionally illustrated in FIG. 10. Thus, on the left in FIG. 10, two axial through holes 8 are illustrated as radially outwardly open grooves 8b, which are delimited in the peripheral direction by corresponding walls 6f of the fixing unit 6. An axial through hole 8 in the fixing ring 2 does not need to be entirely surrounded by material. The sense and purpose of an axial through hole 8 is to provide a non-rotatable connection. It is sufficient for the axial through hole 8 to be confined by a suitable wall, in at least one peripheral direction and, in particular, in both peripheral directions. This configuration may also be provided by means of a radially outwardly, or optionally radially inwardly, open wall, and, in particular, a groove.

In FIG. 10, the spring body 14 of the securing unit 3 is accommodated in the circumferential groove 11, and is retained in the groove by spring force. The securing arm 13 blocks rotation and bears against the wall 6f. The spring body extends arcuate in the peripheral direction over an angle at circumference 12b of more than 180° and more than 270°, and even more than 300°. Preferably, the angle at circumference is less than 360°. This facilitates mounting. Here, the securing arm 13 extends through the central top axial through hole 8 into the plane of the drawing, to engage in an axial takeup 28 of the adjacent disk holder 21.

The relationship of the external diameter 12 of the securing spring 12 to the wall thickness 14b of the spring body 14 is higher than 10:1 and, in particular, higher than 20:1. The spring body 14 consists, in particular, of a spring-elastic material, and may be of a fibrous composite material, though it is preferably made of metal or steel, and, in particular, spring steel.

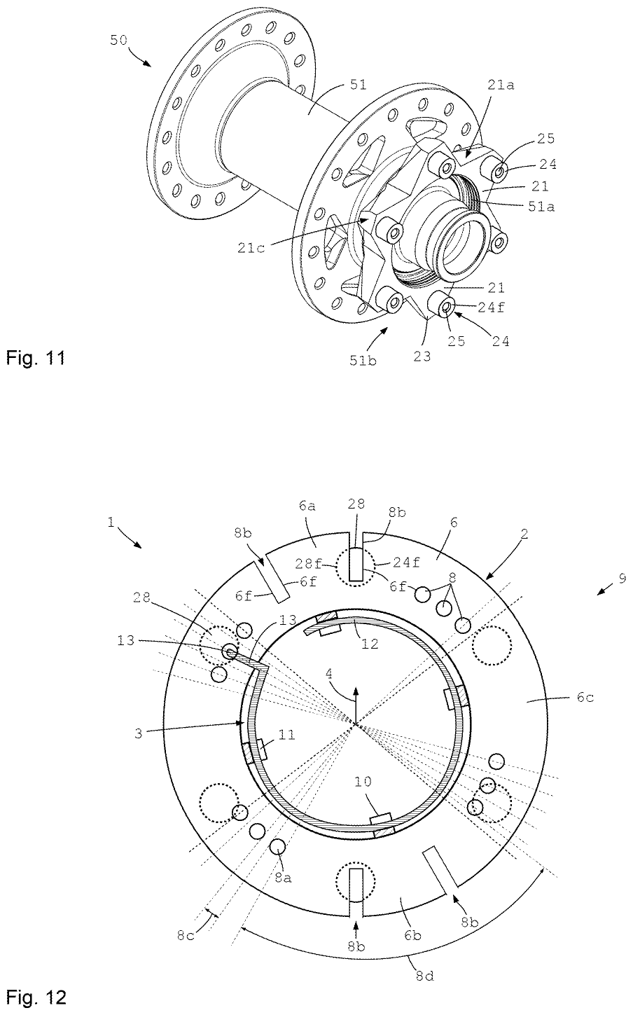

FIG. 11 shows another exemplary embodiment of a bicycle hub 50, on which a disk holder 21 is configured. To this end, the disk holder 21 can be configured or connected with the hub shell 51 in a form-fit or by adhesive bond or integrally. Again, a thread 51a is configured radially in the interior of the disk holder 21, into which the thread 7a of the tube unit 7 of a fixing ring 2 screws.

The approximately star-shaped disk holder is provided with radial arms 23, where one bolt 24 each is configured or received. Again, the bolts may show a depression 25 each, which serve as axial takeups 28 for the end of a securing arm 13 of the securing unit 3. Alternately, the depressions 25 are configured with internal threads 25a, into which screws are screwed, which secure the brake disk in the axial direction. The screws in turn may be provided with apertures serving to receive a securing arm 13.

The configuration according to FIG. 11 shows a configuration according to the application, of a wheel component 1 with a bicycle hub 50, comprising a hub shell 51, and a disk holder 21, and a fixing ring 2, for attaching a separate brake disk 30 to the bicycle hub 50. Axially outwardly of the disk holder 21 (away from a central hub region), six bolts 24 protrude, on which the damping components 27 are accommodated. Furthermore, the brake disk 30 is non-rotatably received on the six disk apertures 38 configured corresponding to the bolts (see FIG. 4). Here the disk holder 21 is configured integrally and, in particular, in a single material with the hub shell 51, and disposed on an axial end region 51b of the hub shell 51. The inner periphery of a longitudinal section 21a of the disk holder 21 shows a thread 51a. By screwing the thread 7a formed on the fixing ring 2 with the thread 51a, a brake disk 30 is attached to the bicycle hub 50 in the axial direction. The brake disk 30 is non-rotatably accommodated by the bolts 24 engaging the disk apertures 38. The brake disk 30 with the disk holder 21 forms a brake disk device 20.

A securing unit 3 serves for securing the fixing ring 2. The fixing ring 2 comprises a fixing unit 6 extending in the radial direction 4, and a tube unit 7 extending in the axial direction, where the thread 7a is configured to screw the thread 7a of the tube unit 7 with the thread 51a on the disk holder 21 respectively on the hub shell 51, and to attach the brake disk device 20 to a bicycle hub 50. The fixing unit 6 comprises at least one axial through hole 8 which is configured and disposed such that the axial through hole 8 is at least in partial axial alignment with an axial takeup 28 in the brake disk device 20 when the fixing ring 2 is in the mounted state, so that a securing arm 13 of the securing unit 3 can be inserted into the takeup 28 of the brake disk device 20 through the through hole 8 in the fixing unit 6, so that the securing arm 13 effects a safety lock for the fixing ring 2 so as to prevent inadvertent detachment of the fixing ring 2. A securing arm 13, in particular, projects into a depression 25 of a bolt 24. Relative rotation is prevented by the wall 24f of the bolt 24.

The exemplary embodiment of FIG. 11 has many advantages. The bicycle hub 50 consists of a reduced quantity of parts. The structure of the bicycle hub 50 is simpler, and its weight can be reduced. It is not required to establish a non-rotatable connection between the hub shell 50 and the disk holder 21, since they are manufactured as one piece. The disk holder 21 is an integral component of the hub. A brake disk can be mounted and attached, and exchanged, directly to the bolts 24 on the disk holder 21. Noises can be effectively damped. The disk brake can be non-rotatably mounted to the hub. The attachment ring or fixing ring 2 in the FIGS. 5 and 6 may serve to axially fix the disk brake. The thread 7a of the attachment ring or fixing ring 2 in the FIG. 6 is screwed into the internal thread 51a configured in the interior of the hub shell 51. The internal thread 51a is located on an axial end of the hub 50, where the disk holder 21 is configured on the hub shell 51.

FIG. 12 finally shows a modification and an exemplary embodiment of a wheel component 1 in a simplistic view, illustrating an axial view of the fixing ring 2. The tube unit 7 with the thread 7a, configured behind the plane of the drawing and thus not visible, runs in the axial direction. One can identify the fixing unit 6, which is in turn configured as a circumferential flange 6c (entirely circumferential or circumferential in sections), or comprising for example separate fixing sections 6a, 6b.

On or in the fixing sections 6a, 6b, or between two fixing sections 6a, 6b, axial through holes 8 may be configured, which may be configured as simple through holes 8a, or as radially open grooves 8b. The axial through holes 8 are delimited in the peripheral direction by at least one wall 6f.

It is also possible and particularly preferred for the axial through holes 8 to be configured as through holes 8a (with completely surrounding walls 6f) on the circumference of the fixing unit 6 or of the fixing flange 6c. In the illustration according to FIG. 12, three approximately opposite through holes 8 are shown, the indicated radii showing that the through holes grouped in threes are disposed at an offset in the peripheral direction of half angular distances each, on opposite sides. This effects increased stability on the fixing unit 6 and simultaneously, larger covering of the through holes 8, at least one of which is intended to align with an axial takeup 28.

In the case of configurations where a brake disk is accommodated through what is called a 6-hole takeup in a disk holder 21, the bolts 24 are usually disposed on the disk holder 21 at circumferential distances of 60°. Two immediately opposite through holes 8 on the fixing unit 6 thus do not increase the chance of a through hole 8 aligning with an axial takeup 28. A configuration of opposite through holes 8 offset by half an angular distance in the circumferential direction, considerably increases the chance of an aligned configuration of an axial through hole 8 with an axial takeup 28.

A number of through holes 8 are disposed over the entire circumference of the fixing flange 6c in an adapted pattern, so that axial alignment of a through hole 8 with an axial takeup 28 is generally enabled, in particular, if one takes into account that a certain amount of increase or decrease of the required screwing momentum of the fixing ring 2 and the hub shell 51 is feasible.

It is also shown that a circumferential distance 8c of two through holes 8 differs from a circumferential distance 8d of two other axial through holes 8.

The difference to the preceding exemplary embodiments is that the tool socket 10 with the non-round contour is configured radially inwardly. Again it is possible for the securing spring 12 to block the tool socket 10 in the mounted state, to prevent applying a tool 60. To this end, the securing spring 12 is again received flexibly resiliently in a circumferential groove 11.

The securing arm 13 protrudes radially from the arcuate spring body, is again axially inserted into a through hole 8 and a corresponding axial takeup 28, and thus forms a safety lock and an anti-twist protection for the fixing ring 2.

In all the configurations it is not necessarily required for the axial takeup 28 to be configured in the disk holder 21. It is also possible to provide the axial takeup 28 on the brake disk. It has as a rule multiple cutouts 31 and disk apertures 38, which can likewise contribute to provide a safety lock and anti-twist protection.

Basically, only a limited return rotation of the fixing ring is required to prevent detachment of the brake disk device 20. In this respect, a contact surface in the brake disk device in the pertaining circumferential direction is sufficient.

All the configurations enable a reliable and simple securing of the brake disk device to a bicycle hub. The components are easy to manufacture and low-cost in production. Moreover, application of a tool is preferably prevented when the securing unit 3 is mounted.

While a particular embodiment of the present wheel component for bicycles with brake disk device have been described herein, it will be appreciated by those skilled in the art that changes and modifications may be made thereto without departing from the invention in its broader aspects and as set forth in the following claims.

List of reference numerals:

| | |
|---|---|
| 1 | wheel component |
| 2 | fixing ring |
| 3 | securing unit |
| 4 | radial direction |
| 5 | axial direction |
| 6 | fixing unit |
| 6a, 6b | fixing section |
| 6c | fixing flange |
| 6d | external diameter |
| 6f | wall |
| 7 | tube unit |
| 7a | thread |
| 8 | through hole at 6 |
| 8a | through hole, hole |
| 8b | groove |
| 8c, 8d | circumferential distance |
| 8e | diameter |
| 9 | mounted state, secured state |
| 10 | tool socket |
| 10a | non-round contour |
| 10b | engagement component |
| 10c | axial groove |
| 11 | circumferential groove |
| 11a | depth of 11 |
| 12 | securing spring |
| 12a | external diameter |
| 12b | angle at circumference |
| 13 | securing arm |
| 13a | length |
| 13b | diameter |
| 14 | spring body |
| 14b | wall thickness |
| 20 | brake disk device |
| 21 | disk holder |
| 21a | longitudinal section |
| 21b | diameter |
| 21c | receiving hole |
| 22 | internal toothing |
| 23 | arm |
| 24 | bolt, journal |
| 24a | length |
| 24f | wall |
| 25 | depression; hole in bolt |
| 25a | thread |
| 26 | basic body of 21 |
| 26a | cross sectional plane |
| 27 | damping component |
| 27a | spring part |
| 27b | damping part |
| 28 | axial takeup; aperture in 20 |
| 28a | diagonal distance, diameter |
| 28b | diameter of 28 |
| 28f | wall |
| 30 | brake disk |
| 30a | disk plane |
| 30b | disk thickness |
| 31 | cutout |
| 31f | wall |
| 32 | bolt takeup |
| 38 | disk aperture axial aperture in 30 |
| 40 | fastening unit |
| 41 | head |
| 50 | bicycle hub |
| 51 | hub shell |
| 51a | thread |
| 51b | end region |
| 52 | shoulder |
| 53 | toothing |
| 54 | clamping system |
| 55 | takeup device |
| 60 | tool |
| 61 | engagement component |
| 100 | bicycle |
| 101 | wheel, front wheel |
| 102 | wheel, rear wheel |
| 103 | frame |
| 104 | fork, suspension fork |
| 105 | rear wheel damper |
| 106 | handlebar, handle |
| 107 | saddle |
| 109 | spoke |
| 110 | rim |
| 112 | pedal crank |

1. A wheel component for bicycles with a brake disk device comprising: a disk holder and a brake disk provided to be attached to the disk holder; wherein the brake disk opens up a disk plane;
wherein the disk holder comprises a basic body having a central cross sectional plane, which extends in parallel to the disk plane; wherein the basic body is configured with a plurality of bolts, which protrude in the axial direction and pass through the disk plane, to receive the brake disk on the disk holder;
wherein at least one fastening unit is comprised to secure the brake disk on the disk holder; and between the basic body of the disk holder and the fastening unit, at least one elastic damping component contacting the brake disk is received, to accommodate the brake disk on the disk holder float-mounted and noise-reducing.

2. The wheel component according to claim 1, wherein the brake disk is received on the disk holder axially and/or radially float-mounted.

3. The wheel component according to claim 1, wherein at least one elastic damping component is axially received between the disk holder and the brake disk,
and/or wherein at least one elastic damping component is axially received between the brake disk and the fastening unit.

4. The wheel component according to claim 1, wherein at least one damping component comprises an O-ring.

5. The wheel component according to claim 1, wherein multiple fastening units secure the brake disk to the bolts.

6. The wheel component according to claim 1, wherein at least one bolt comprises an axial bore.

7. The wheel component according to claim 6, wherein at least one bolt comprises an internal thread in the bore, in which a screw is inserted as a fastening unit.

8. The wheel component according to claim 1, wherein a (freely protruding) axial length of the bolt (to receive the brake disk) is larger than the disk thickness of the brake disk in the accommodation region of the bolt.

9. The wheel component according to claim 1, wherein the disk thickness of the brake disk plus the axial width of the damping component is larger in the non-mounted state than is the axial length of the bolt.

10. The wheel component according to claim 1, wherein one damping component is disposed on each of the two axial sides of the brake disk, and wherein in particular one damping component is disposed on at least one bolt on the two axial sides of the brake disk.

11. The wheel component according to claim 1, wherein a spring member is disposed on one of the axial sides of the brake disk, and on the other of the axial sides, a damping component.

12. The wheel component according to claim 1 with a fixing ring for attaching the brake disk device to the hub shell of a bicycle hub,
wherein the fixing ring comprises a fixing unit extending in the radial direction, and a tube unit extending in the axial direction on which a thread is configured to screw the thread of the tube unit with the thread on the hub shell and to attach the brake disk device to a bicycle hub.

13. The wheel component according to claim 12, comprising a securing unit for securing the fixing ring.

14. The wheel component according to claim 13, wherein the fixing unit comprises at least one axial through hole, which is configured and disposed such that the axial through hole is at least in partial axial alignment with an axial takeup in the brake disk device in the mounted state of the fixing ring, so that a securing arm of the securing unit can be inserted into the takeup of the brake disk device through the through hole in the fixing unit, so that the securing arm effects a safety lock for the fixing ring so as to prevent inadvertent detachment of the fixing ring.

15. The wheel component according to claim 14, wherein a plurality of axial takeups is configured distributed over the circumference of the brake disk device, and/or wherein a plurality of axial through holes is configured over the circumference of the fixing unit.

16. The wheel component according to claim 15, wherein the distribution of the axial through holes is selected such that a safety lock of the fixing ring is enabled in any angular position of the fixing unit.

17. The wheel component according to claim 1, wherein the fixing unit comprises at least one fixing section extending in the radial direction, and wherein an axial through hole is configured in the fixing section, or wherein an axial through hole is configured between two adjacent fixing sections.

18. The wheel component according to claim 1, wherein the fixing unit comprises a circumferential fixing flange, and wherein the fixing flange serves as a fastening unit and secures the brake disk in particular to multiple bolts.

19. The wheel component according to claim 1, wherein the securing arm shows an arm diameter that is smaller than the diameter of the axial through hole and the axial takeup, so that inserting the securing arm is possible even if the axial through hole is not in perfect alignment with the axial takeup.

20. The wheel component according to claim 1, wherein the fixing ring comprises at least one tool socket showing a non-round contour, so that it can be gripped with an adapted tool, and wherein the securing unit locks the tool socket in the mounted state.

21. The wheel component according to claim 20, wherein the brake disk device is disposed on one axial side of the fixing unit in the mounted state, and the tool socket is configured on the other axial side of the fixing unit.

22. The wheel component according to claim 20, wherein the tool socket is configured radially on the tube unit.

23. The wheel component according to claim 1, wherein a substantially circumferential groove is configured on the fixing ring.

24. The wheel component according to claim 1, wherein the securing unit comprises a securing spring with an arcuate spring body, from which the securing arm protrudes transversely, and wherein the securing spring bears flexibly resiliently against the fixing ring in the mounted state.

25. The wheel component according to claim 24, wherein the groove is configured on the tool socket, and the securing spring is received in the groove of the tool socket in the mounted state, and wherein the groove shows dimensions such that in the mounted state the spring body radially protrudes out of the groove.

26. The wheel component according to claim 25, wherein in the mounted state the spring body is received in the tool socket such that the tool cannot be applied to the tool socket.

27. The wheel component according to claim 1, wherein the spring body opens up a plane to which the securing arm is oriented transverse.

28. The wheel component according to claim 1, wherein the disk holder can be non-rotatably connected with the bicycle hub and in the mounted state bears against a shoulder of the hub shell, or wherein the disk holder is provided to be attached to a separate adapter unit, which can be attached to the hub shell.

29. The wheel component according to claim 1, wherein the disk holder is connected with the bicycle hub by adhesive bond.

30. The wheel component according to claim 1, wherein at least one bolt comprises as an axial takeup at the axial end of the bolt, a depression which is accessible in the mounted state, and wherein in the mounted state the securing arm engages the depression.

31. The wheel component according to claim 1, wherein the external diameter of the fixing unit is larger than the diagonal distance of the axial takeups.
